(19) United States
(12) Patent Application Publication
(10) Pub. No.: US 2022/0035062 A1
(43) Pub. Date: Feb. 3, 2022

(54) Semi-airborne Time Domain Electromagnetic Exploration System for Unmanned Aerial Vehicle

(71) Applicant: Chengdu University of technology, Chengdu City (CN)

(72) Inventors: Xuben Wang, Chengdu City (CN); Song Gao, Chengdu City (CN); Jiafu Ren, Chengdu City (CN); Yuan Li, Chengdu City (CN); Congde Lu, Chengdu City (CN); Lifeng Mao, Chengdu City (CN); Linlin Li, Chengdu City (CN)

(21) Appl. No.: 17/349,058

(22) Filed: Jun. 16, 2021

(30) Foreign Application Priority Data
Jul. 30, 2020 (CN) 2020107500973

(51) Int. Cl. G01V 3/17; G01V 3/16; G01V 3/38

(52) U.S. Cl. CPC G01V 3/17; G01V 3/38; G01V 3/16

(57) ABSTRACT

The invention discloses a semi-airborne time domain electromagnetic exploration system for an unmanned aerial vehicle, and belongs to the technical field of geophysical electromagnetic exploration. The system comprises a ground high-power electromagnetic field source emission subsystem, a semi-airborne time domain electromagnetic exploration and observation subsystem and a data processing interpretation software subsystem, wherein the ground high-power electromagnetic field source emission subsystem comprises an IGBT full bridge, a PWM control circuit, a rectification filter circuit and a protection circuit; the semi-airborne time domain electromagnetic exploration and observation subsystem comprises an unmanned aerial vehicle, a receiving coil and a receiver; the data processing interpretation software subsystem comprises a system function module and a bottom layer supporting module, and the bottom layer supporting module is used for providing a universal performance function for the system function module. The system adopts a grounding line source, is relatively easy to arrange, supplies large current to the ground, is large in detection depth, makes the receiving coil fly in the form of a serpentine line parallel to a wire source, can maintain an equal offset distance of each measuring line, and makes data processing and inversion interpretation relatively simple.

### CROSS REFERENCE TO RELATED APPLICATION

The invention relates to the technical field of geophysical electromagnetic exploration, in particular to a semi-airborne time domain electromagnetic exploration system for an unmanned aerial vehicle.

### BACKGROUND OF THE INVENTION

The airborne electromagnetic method is a geophysical exploration method with a high speed and a wide application range, in which a helicopter or a fixed-wing aircraft is mainly adopted to carry a launching and observing system. As a rapid-developing detection method in the field of electromagnetic exploration in the 21st century, the airborne electromagnetic method is mainly used in large-area regional geological exploration with a high safety risk factor. With the continuous development of the unmanned aerial vehicle (UAV) technology, the UAV can be adopted as a platform to carry airborne electromagnetic detection equipment so as to adapt to rapid exploration in relatively small areas. However, due to the limitations on load capacity and endurance capacity of the current UAV, the weight of the electromagnetic equipment carried is limited. Therefore, a new airborne electromagnetic method is proposed, that is, ground transmission is adopted, and the UAV is equipped with the receiving coil for air reception. This method, also known as the semi-airborne electromagnetic method, has the advantages of higher precision, convenient implementation, lower cost and good safety compared with the conventional airborne electromagnetic method, and has the advantage of higher exploration speed compared with a conventional ground electromagnetic method. Moreover, the semi-airborne electromagnetic method has a wide application prospect in the fields of geological exploration, mineral resource exploration and environmental monitoring.

The Chinese patent document with the publication number being CN 103576205A and the publication date on Feb. 12, 2014 discloses a ground-airborne transient electromagnetic exploration based on a combined magnetic source technology, including arranging magnetic sources for emitting periodic bipolar current pulse signals on ground to receive an induced electromotive force transient signal by a coil, The characteristics are as follows: the magnetic sources are 4, 6 or 8, and each magnetic source is evenly distributed on a circle centered on the exploration target area; the receiving coil is carried on the UAV which flies above the target exploration area to acquire induced electromotive force transient response data under excitation of each combined source, and the combined source refers to an excitation source consisting of several or all symmetrically distributed magnetic sources. The ground-airborne transient electromagnetic exploration based on the combined magnetic source technology disclosed in this patent document is not only difficult to deploy magnetic sources in complex terrain areas such as mountains, lakes, and swamps, but also has a relatively shallow detection depth, where the transmitter can only provide power of the magnetic sources, the position of the receiving coil in the serpentine flight changes according to the size of receiving-sending distances and receiving signals for a magnetic emission source, and thus, data processing is difficult.

### SUMMARY OF THE INVENTION

In order to overcome the above-mentioned shortcomings of the prior art, the invention provides a semi-airborne time domain electromagnetic exploration system for an unmanned aerial vehicle. The system adopts a grounding line source, is relatively easy to arrange, supplies large current to the ground, is large in detection depth, makes the receiving coil fly in the form of a serpentine line parallel to a wire source, can maintain an equal offset distance of each measuring line, and makes data processing and inversion interpretation relatively simple.

The invention adopts the following technical scheme:

A semi-airborne time domain electromagnetic exploration system for an unmanned aerial vehicle is characterized by including a ground high-power electromagnetic field source emission subsystem, a semi-airborne time domain electromagnetic exploration and observation subsystem and a data processing interpretation software subsystem, where the ground high-power electromagnetic field source emission subsystem includes an IGBT full bridge, a PWM control circuit, a rectification filter circuit and a protection circuit, which define a high-power inversion emission circuit; the semi-airborne time domain electromagnetic exploration and observation subsystem includes an unmanned aerial vehicle, a receiving coil hung on the unmanned aerial vehicle and a receiver mounted on the unmanned aerial vehicle; the data processing interpretation software subsystem includes a system function module and a bottom layer supporting module, where the system function module includes a data file management module, a preprocessing module, a forward module, an inversion module and an image-forming module; the bottom layer supporting module includes a data file IO module, an embedded type database module, a universal math library module, a universal signal processing library module and an 2D/3D graphics library module; and the bottom layer supporting module is used for providing a universal performance function for the system function module.

The receiving coil is a hollow core induction coil wound by a copper wire, includes a coil and a differential preamplifier connected to both ends of the coil, and is used to detect electromagnetic response signals of geological bodies in the exploration areas.

The receiving coil is hung below the unmanned aerial vehicle by a nylon belt, and the nylon belt and the receiving coil are connected by a spring shock absorber.

The receiver is encapsulated in an aluminum metal shell, and is mounted under the unmanned aerial vehicle through a bracket and an airbag shock absorber.

The receiver includes an analog signal conditioning module, a signal acquisition module based on ADC and FPGA, an ARM embedded system control module, a GPS transceiver synchronization module, a CF card storage module, a WIFI module, an attitude sensor and a laser altimeter. The signal detected by the receiving coil is amplified, filtered and stored by the receiver in real time.

The analog signal conditioning module is connected to the differential preamplifier of the receiving coil through a shielded wire to amplify and filter the received weak detection signal and convert it into a level matching with the ADC input end; the signal acquisition module based on ADC and FPGA starts ADC sampling every second under control of the second synchronization pulse of the ARM embedded system control module, converts the analog signal into a digital signal, and encapsulates it into a frame for being stored into the CF card storage module; the GPS transceiver synchronization module is connected to an external GPS antenna for providing real-time coordinates and time information as well as the second synchronization pulse to the receiver; the WIFI module is connected to a handheld terminal for setting parameters of the receiver; the attitude sensor is attached to a receiving coil housing; the attitude sensor is kept consistent with the receiving coil in motion attitude, and is connected to the receiver through a RS-485 bus; the laser altimeter is mounted under the unmanned aerial vehicle and is perpendicular to the horizontal plane of the machine body of the unmanned aerial vehicle; a laser emitting and receiving hole faces towards the ground; and the laser altimeter is used for measuring relative height of the unmanned aerial vehicle and the ground.

Output current of the ground high-power electromagnetic field source emission subsystem is 50-100 A, the emission fundamental frequency is 1.25-200 Hz, the maximum rated power is 30 KW, the output current stability is less than ±1%, and the turn-off time is less than 20 μs.

The basic principle of the invention is as follows:

The grounding wire source is adopted, pits with a depth of about 1 m are dug at both ends, multiple copper or aluminum polar plates are buried, and the current is directly applied to the ground in the detection area, the ground high-power electromagnetic field source emission subsystem transmits bipolar square-wave current to the underground to generate changing electromagnetic fields, namely the primary fields for exciting underground geological bodies, and induced eddy current of the underground geological bodies generates time-varying induced electromagnetic fields, namely the secondary fields; then, the semi-airborne time domain electromagnetic exploration and observation subsystem for the unmanned aerial vehicle is adopted to synchronously receive and record the electromagnetic response during the operation of the field source; and finally, the secondary fields are extracted through the data processing interpretation software subsystem, and are superimposed, denoised and inverted so as to achieve the purpose of detecting the target body.

The beneficial effects of the invention are mainly manifested in the following aspects:

Firstly, the invention is a time domain electromagnetic exploration system adopting the “ground launching and air receiving” mode. Compared with the ground time domain electromagnetic system and the airborne time domain electromagnetic system, it has the characteristics of convenient operation, high efficiency, a large detection range, a high signal-to-noise ratio and good spatial resolution; the invention adopts a grounding line source, is relatively easy to arrange, supplies large current to the ground, is large in detection depth, makes the receiving coil fly in the form of a serpentine line parallel to a wire source, can maintain an equal offset distance of each measuring line, and makes data processing and inversion interpretation relatively simple; and the electromagnetic exploration method is suitable for detection in mountains, undulating terrains and swamps, and has obvious advantages and effects in underground metal sulfide deposit finding and rapid geological engineering exploration.

Secondly, the invention is also suitable for fine exploration of small areas such as rivers and lakes, large-scale urban garbage dumps, and landslides, which have complex terrains and are difficult to reach by personnel, and can effectively solve the multi-field exploration problems of underground water, minerals, geological disasters and underground environment evaluation. While ensuring higher detection accuracy, it can quickly complete detection, processing interpretation tasks, and can solve rapid exploration in a small area.

Thirdly, the invention adopts a grounding line source, digs pits with depths of 1 m in both ends, buries copper or aluminum polar plates, and applies the current directly to the ground in the detection area. The operating conditions are easy to meet, and the detection depth is relatively large; and the ground high-power emitter can provide power for the electrical source with resistive load and the magnetic source with inductive load.

### BRIEF DESCRIPTION OF THE DRAWINGS

In the following, the invention will be further described in detail with reference to the drawings and specific embodiments of the specification:

FIG. 1 is a principle block diagram of the ground high-power electromagnetic field source emission subsystem.

FIG. 2 is a circuit principle block diagram of the receiver.

FIG. 3 is a flowchart of the data processing interpretation software subsystem.

### DETAILED DESCRIPTION OF THE PREFERRED EMBODIMENTS

### Embodiment 1

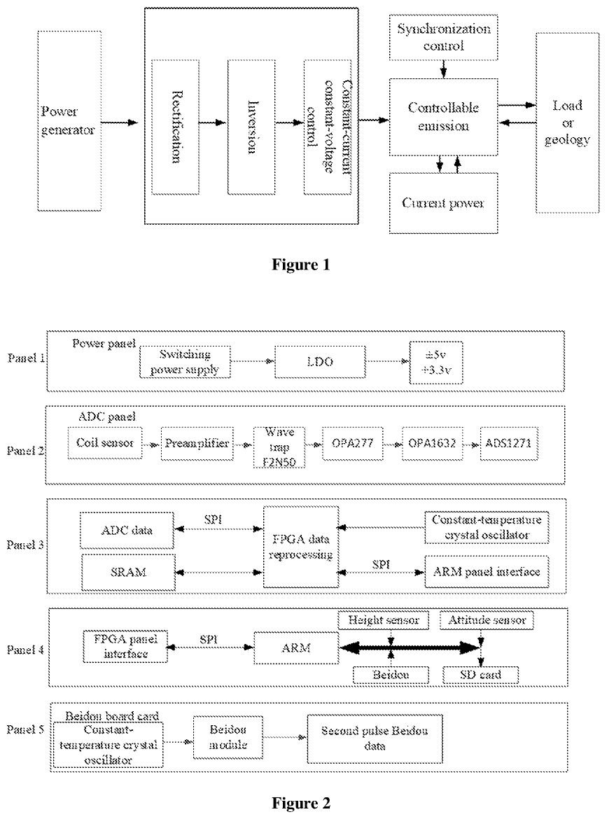

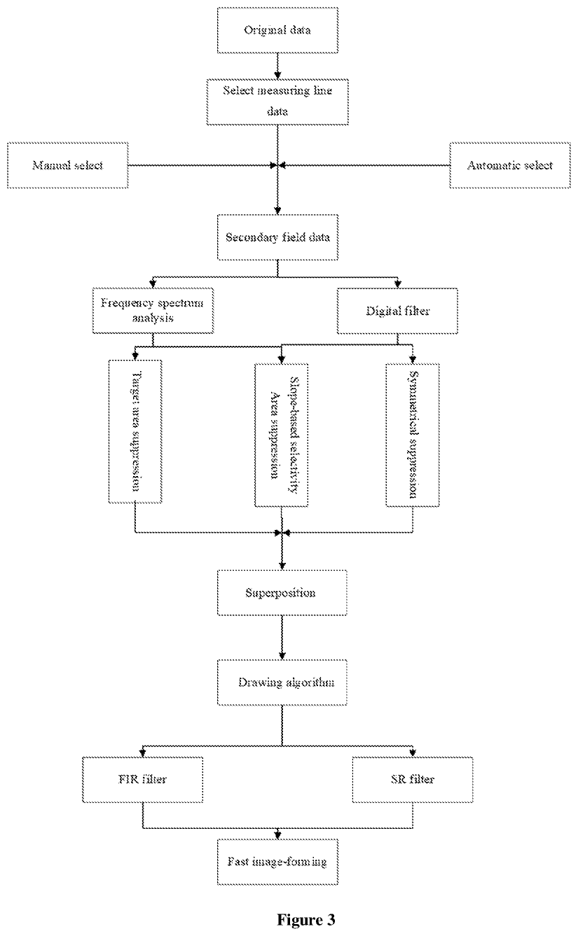

Refer to FIG. 1 to FIG. 3, a semi-airborne time domain electromagnetic exploration system for an unmanned aerial vehicle includes a ground high-power electromagnetic field source emission subsystem, a semi-airborne time domain electromagnetic exploration and observation subsystem and a data processing interpretation software subsystem, where the ground high-power electromagnetic field source emission subsystem includes an IGBT full bridge, a PWM control circuit, a rectification filter circuit and a protection circuit, which define a high-power inversion emission circuit; the semi-airborne time domain electromagnetic exploration and observation subsystem includes an unmanned aerial vehicle, a receiving coil hung on the unmanned aerial vehicle and a receiver mounted on the unmanned aerial vehicle; the data processing interpretation software subsystem includes a system function module and a bottom layer supporting module, where the system function module includes a data file management module, a preprocessing module, a forward module, an inversion module and an image-forming module; the bottom layer supporting module includes a data file IO module, an embedded type database module, a universal math library module, a universal signal processing library module and an 2D/3D graphics library module; and the bottom layer supporting module is used for providing a universal performance function for the system function module.

Compared with the ground time domain electromagnetic system and the airborne time domain electromagnetic system, it has the characteristics of convenient operation, high efficiency, a large detection range, a high signal-to-noise ratio and good spatial resolution; the invention adopts a grounding line source, is relatively easy to arrange, supplies large current to the ground, is large in detection depth, makes the receiving coil fly in the form of a serpentine line parallel to a wire source, can maintain an equal offset distance of each measuring line, and makes data processing and inversion interpretation relatively simple; and the electromagnetic exploration method is suitable for detection in mountains, undulating terrains and swamps, and has obvious advantages and effects in underground metal sulfide deposit finding and rapid geological engineering exploration.

### Embodiment 2

Refer to FIG. 1 to FIG. 3, a semi-airborne time domain electromagnetic exploration system for an unmanned aerial vehicle includes a ground high-power electromagnetic field source emission subsystem, a semi-airborne time domain electromagnetic exploration and observation subsystem and a data processing interpretation software subsystem, where the ground high-power electromagnetic field source emission subsystem includes an IGBT full bridge, a PWM control circuit, a rectification filter circuit and a protection circuit, which define a high-power inversion emission circuit; the semi-airborne time domain electromagnetic exploration and observation subsystem includes an unmanned aerial vehicle, a receiving coil hung on the unmanned aerial vehicle and a receiver mounted on the unmanned aerial vehicle; the data processing interpretation software subsystem includes a system function module and a bottom layer supporting module, where the system function module includes a data file management module, a preprocessing module, a forward module, an inversion module and an image-forming module; the bottom layer supporting module includes a data file IO module, an embedded type database module, a universal math library module, a universal signal processing library module and an 2D/3D graphics library module; and the bottom layer supporting module is used for providing a universal performance function for the system function module.

The receiving coil is a hollow core induction coil wound by a copper wire, includes a coil and a differential preamplifier connected to both ends of the coil, and is used to detect electromagnetic response signals of geological bodies in the exploration areas.

The receiving coil is hung below the unmanned aerial vehicle by a nylon belt, and the nylon belt and the receiving coil are connected by a spring shock absorber.

The receiver is encapsulated in an aluminum metal shell, and is mounted under the unmanned aerial vehicle through a bracket and an airbag shock absorber.

### Embodiment 3

Refer to FIG. 1 to FIG. 3, a semi-airborne time domain electromagnetic exploration system for an unmanned aerial vehicle includes a ground high-power electromagnetic field source emission subsystem, a semi-airborne time domain electromagnetic exploration and observation subsystem and a data processing interpretation software subsystem, where the ground high-power electromagnetic field source emission subsystem includes an IGBT full bridge, a PWM control circuit, a rectification filter circuit and a protection circuit, which define a high-power inversion emission circuit; the semi-airborne time domain electromagnetic exploration and observation subsystem includes an unmanned aerial vehicle, a receiving coil hung on the unmanned aerial vehicle and a receiver mounted on the unmanned aerial vehicle; the data processing interpretation software subsystem includes a system function module and a bottom layer supporting module, where the system function module includes a data file management module, a preprocessing module, a forward module, an inversion module and an image-forming module; the bottom layer supporting module includes a data file IO module, an embedded type database module, a universal math library module, a universal signal processing library module and an 2D/3D graphics library module; and the bottom layer supporting module is used for providing a universal performance function for the system function module.

The receiving coil is a hollow core induction coil wound by a copper wire, includes a coil and a differential preamplifier connected to both ends of the coil, and is used to detect electromagnetic response signals of geological bodies in the exploration areas.

The receiving coil is hung below the unmanned aerial vehicle by a nylon belt, and the nylon belt and the receiving coil are connected by a spring shock absorber.

The receiver is encapsulated in an aluminum metal shell, and is mounted under the unmanned aerial vehicle through a bracket and an airbag shock absorber.

The receiver includes an analog signal conditioning module, a signal acquisition module based on ADC and FPGA, an ARM embedded system control module, a GPS transceiver synchronization module, a CF card storage module, a WIFI module, an attitude sensor and a laser altimeter. The signal detected by the receiving coil is amplified, filtered and stored by the receiver in real time.

The analog signal conditioning module is connected to the differential preamplifier of the receiving coil through a shielded wire to amplify and filter the received weak detection signal and convert it into a level matching with the ADC input end; the signal acquisition module based on ADC and FPGA starts ADC sampling every second under control of the second synchronization pulse of the ARM embedded system control module, converts the analog signal into a digital signal, and encapsulates it into a frame for being stored into the CF card storage module; the GPS transceiver synchronization module is connected to an external GPS antenna for providing real-time coordinates and time information as well as the second synchronization pulse to the receiver; the WIFI module is connected to a handheld terminal for setting parameters of the receiver; the attitude sensor is attached to a receiving coil housing; the attitude sensor is kept consistent with the receiving coil in motion attitude, and is connected to the receiver through a RS-485 bus; the laser altimeter is mounted under the unmanned aerial vehicle and is perpendicular to the horizontal plane of the machine body of the unmanned aerial vehicle; a laser emitting and receiving hole faces towards the ground; and the laser altimeter is used for measuring relative height of the unmanned aerial vehicle and the ground.

The invention is also suitable for fine exploration of small areas such as rivers and lakes, large-scale urban garbage dumps, and landslides, which have complex terrains and are difficult to reach by personnel, and can effectively solve the multi-field exploration problems of underground water, minerals, geological disasters and underground environment evaluation. While ensuring higher detection accuracy, it can quickly complete detection, processing interpretation tasks, and can solve rapid exploration in a small area.

### Embodiment 4

Refer to FIG. 1 to FIG. 3, a semi-airborne time domain electromagnetic exploration system for an unmanned aerial vehicle includes a ground high-power electromagnetic field source emission subsystem, a semi-airborne time domain electromagnetic exploration and observation subsystem and a data processing interpretation software subsystem, where the ground high-power electromagnetic field source emission subsystem includes an IGBT full bridge, a PWM control circuit, a rectification filter circuit and a protection circuit, which define a high-power inversion emission circuit; the semi-airborne time domain electromagnetic exploration and observation subsystem includes an unmanned aerial vehicle, a receiving coil hung on the unmanned aerial vehicle and a receiver mounted on the unmanned aerial vehicle; the data processing interpretation software subsystem includes a system function module and a bottom layer supporting module, where the system function module includes a data file management module, a preprocessing module, a forward module, an inversion module and an image-forming module; the bottom layer supporting module includes a data file IO module, an embedded type database module, a universal math library module, a universal signal processing library module and an 2D/3D graphics library module; and the bottom layer supporting module is used for providing a universal performance function for the system function module.

The receiving coil is a hollow core induction coil wound by a copper wire, includes a coil and a differential preamplifier connected to both ends of the coil, and is used to detect electromagnetic response signals of geological bodies in the exploration areas.

The receiving coil is hung below the unmanned aerial vehicle by a nylon belt, and the nylon belt and the receiving coil are connected by a spring shock absorber.

The receiver is encapsulated in an aluminum metal shell, and is mounted under the unmanned aerial vehicle through a bracket and an airbag shock absorber.

The receiver includes an analog signal conditioning module, a signal acquisition module based on ADC and FPGA, an ARM embedded system control module, a GPS transceiver synchronization module, a CF card storage module, a WIFI module, an attitude sensor and a laser altimeter. The signal detected by the receiving coil is amplified, filtered and stored by the receiver in real time.

The analog signal conditioning module is connected to the differential preamplifier of the receiving coil through a shielded wire to amplify and filter the received weak detection signal and convert it into a level matching with the ADC input end; the signal acquisition module based on ADC and FPGA starts ADC sampling every second under control of the second synchronization pulse of the ARM embedded system control module, converts the analog signal into a digital signal, and encapsulates it into a frame for being stored into the CF card storage module; the GPS transceiver synchronization module is connected to an external GPS antenna for providing real-time coordinates and time information as well as the second synchronization pulse to the receiver; the WIFI module is connected to a handheld terminal for setting parameters of the receiver; the attitude sensor is attached to a receiving coil housing; the attitude sensor is kept consistent with the receiving coil in motion attitude, and is connected to the receiver through a RS-485 bus; the laser altimeter is mounted under the unmanned aerial vehicle and is perpendicular to the horizontal plane of the machine body of the unmanned aerial vehicle; a laser emitting and receiving hole faces towards the ground; and the laser altimeter is used for measuring relative height of the unmanned aerial vehicle and the ground.

Output current of the ground high-power electromagnetic field source emission subsystem is 50 A, the emission fundamental frequency is 1.25 Hz, the maximum rated power is 30 KW, the output current stability is less than ±1%, and the turn-off time is less than 20 μs.

### Embodiment 5

Refer to FIG. 1 to FIG. 3, a semi-airborne time domain electromagnetic exploration system for an unmanned aerial vehicle includes a ground high-power electromagnetic field source emission subsystem, a semi-airborne time domain electromagnetic exploration and observation subsystem and a data processing interpretation software subsystem, where the ground high-power electromagnetic field source emission subsystem includes an IGBT full bridge, a PWM control circuit, a rectification filter circuit and a protection circuit, which define a high-power inversion emission circuit; the semi-airborne time domain electromagnetic exploration and observation subsystem includes an unmanned aerial vehicle, a receiving coil hung on the unmanned aerial vehicle and a receiver mounted on the unmanned aerial vehicle; the data processing interpretation software subsystem includes a system function module and a bottom layer supporting module, where the system function module includes a data file management module, a preprocessing module, a forward module, an inversion module and an image-forming module; the bottom layer supporting module includes a data file IO module, an embedded type database module, a universal math library module, a universal signal processing library module and an 2D/3D graphics library module; and the bottom layer supporting module is used for providing a universal performance function for the system function module.

The receiving coil is a hollow core induction coil wound by a copper wire, includes a coil and a differential preamplifier connected to both ends of the coil, and is used to detect electromagnetic response signals of geological bodies in the exploration areas.

The receiving coil is hung below the unmanned aerial vehicle by a nylon belt, and the nylon belt and the receiving coil are connected by a spring shock absorber.

The receiver is encapsulated in an aluminum metal shell, and is mounted under the unmanned aerial vehicle through a bracket and an airbag shock absorber.

The receiver includes an analog signal conditioning module, a signal acquisition module based on ADC and FPGA, an ARM embedded system control module, a GPS transceiver synchronization module, a CF card storage module, a WIFI module, an attitude sensor and a laser altimeter. The signal detected by the receiving coil is amplified, filtered and stored by the receiver in real time.

The analog signal conditioning module is connected to the differential preamplifier of the receiving coil through a shielded wire to amplify and filter the received weak detection signal and convert it into a level matching with the ADC input end; the signal acquisition module based on ADC and FPGA starts ADC sampling every second under control of the second synchronization pulse of the ARM embedded system control module, converts the analog signal into a digital signal, and encapsulates it into a frame for being stored into the CF card storage module; the GPS transceiver synchronization module is connected to an external GPS antenna for providing real-time coordinates and time information as well as the second synchronization pulse to the receiver; the WIFI module is connected to a handheld terminal for setting parameters of the receiver; the attitude sensor is attached to a receiving coil housing; the attitude sensor is kept consistent with the receiving coil in motion attitude, and is connected to the receiver through a RS-485 bus; the laser altimeter is mounted under the unmanned aerial vehicle and is perpendicular to the horizontal plane of the machine body of the unmanned aerial vehicle; a laser emitting and receiving hole faces towards the ground; and the laser altimeter is used for measuring relative height of the unmanned aerial vehicle and the ground.

Output current of the ground high-power electromagnetic field source emission subsystem is 80 A, the emission fundamental frequency is 80 Hz, the maximum rated power is 30 KW, the output current stability is less than ±1%, and the turn-off time is less than 20 μs.

The invention adopts a grounding line source, digs pits with depths of 1 m in both ends, buries copper or aluminum polar plates, and applies the current directly to the ground in the detection area. The operating conditions are easy to meet, and the detection depth is relatively large; and the ground high-power emitter can provide power for the electrical source with resistive load and the magnetic source with inductive load

### Embodiment 6

Refer to FIG. 1 to FIG. 3, a semi-airborne time domain electromagnetic exploration system for an unmanned aerial vehicle includes a ground high-power electromagnetic field source emission subsystem, a semi-airborne time domain electromagnetic exploration and observation subsystem and a data processing interpretation software subsystem, where the ground high-power electromagnetic field source emission subsystem includes an IGBT full bridge, a PWM control circuit, a rectification filter circuit and a protection circuit, which define a high-power inversion emission circuit; the semi-airborne time domain electromagnetic exploration and observation subsystem includes an unmanned aerial vehicle, a receiving coil hung on the unmanned aerial vehicle and a receiver mounted on the unmanned aerial vehicle; the data processing interpretation software subsystem includes a system function module and a bottom layer supporting module, where the system function module includes a data file management module, a preprocessing module, a forward module, an inversion module and an image-forming module; the bottom layer supporting module includes a data file IO module, an embedded type database module, a universal math library module, a universal signal processing library module and an 2D/3D graphics library module; and the bottom layer supporting module is used for providing a universal performance function for the system function module.

The receiving coil is a hollow core induction coil wound by a copper wire, includes a coil and a differential preamplifier connected to both ends of the coil, and is used to detect electromagnetic response signals of geological bodies in the exploration areas.

The receiving coil is hung below the unmanned aerial vehicle by a nylon belt, and the nylon belt and the receiving coil are connected by a spring shock absorber.

The receiver is encapsulated in an aluminum metal shell, and is mounted under the unmanned aerial vehicle through a bracket and an airbag shock absorber.

The receiver includes an analog signal conditioning module, a signal acquisition module based on ADC and FPGA, an ARM embedded system control module, a GPS transceiver synchronization module, a CF card storage module, a WIFI module, an attitude sensor and a laser altimeter. The signal detected by the receiving coil is amplified, filtered and stored by the receiver in real time.

The analog signal conditioning module is connected to the differential preamplifier of the receiving coil through a shielded wire to amplify and filter the received weak detection signal and convert it into a level matching with the ADC input end; the signal acquisition module based on ADC and FPGA starts ADC sampling every second under control of the second synchronization pulse of the ARM embedded system control module, converts the analog signal into a digital signal, and encapsulates it into a frame for being stored into the CF card storage module; the GPS transceiver synchronization module is connected to an external GPS antenna for providing real-time coordinates and time information as well as the second synchronization pulse to the receiver; the WIFI module is connected to a handheld terminal for setting parameters of the receiver; the attitude sensor is attached to a receiving coil housing; the attitude sensor is kept consistent with the receiving coil in motion attitude, and is connected to the receiver through a RS-485 bus; the laser altimeter is mounted under the unmanned aerial vehicle and is perpendicular to the horizontal plane of the machine body of the unmanned aerial vehicle; a laser emitting and receiving hole faces towards the ground; and the laser altimeter is used for measuring relative height of the unmanned aerial vehicle and the ground.

Output current of the ground high-power electromagnetic field source emission subsystem is 100 A, the emission fundamental frequency is 200 Hz, the maximum rated power is 30 KW, the output current stability is less than ±1%, and the turn-off time is less than 20 μs.

In the principle block diagram of the ground high-power electromagnetic field source emission subsystem, the ground high-power electromagnetic field source emission subsystem includes two parts: a high-power generator set and a high-power electromagnetic field emitter. The high-power generator set adopts a mature three-phase AC380V or three-phase AC220V diesel or gasoline generator set on the market.

The semi-airborne time domain electromagnetic exploration principle for the unmanned aerial vehicle is as follows:

The ground high-power electromagnetic field source emission subsystem outputs bipolar square waves, and uses the grounding line source to send primary transient electromagnetic fields to the ground to excite the geological bodies to generate an induced eddy current. This induced eddy current will generate induced electromagnetic fields that decay over time, which are called as secondary fields; and during the turn-off interval of the primary transient electromagnetic fields, the secondary fields are received by the semi-airborne time domain electromagnetic exploration and observation subsystem, and the electromagnetic response information in the secondary fields is extracted and analyzed through the data processing and interpretation software subsystem so as to obtain the electrical conductivity and the spatial forms of the geological bodies.

What is claimed is:

1. A semi-airborne time domain electromagnetic exploration system for an unmanned aerial vehicle is characterized by comprising a ground high-power electromagnetic field source emission subsystem, a semi-airborne time domain electromagnetic exploration and observation subsystem and a data processing interpretation software subsystem, wherein the ground high-power electromagnetic field source emission subsystem comprises an IGBT full bridge, a PWM control circuit, a rectification filter circuit and a protection circuit, which define a high-power inversion emission circuit; the semi-airborne time domain electromagnetic exploration and observation subsystem comprises an unmanned aerial vehicle, a receiving coil hung on the unmanned aerial vehicle and a receiver mounted on the unmanned aerial vehicle; the data processing interpretation software subsystem comprises a system function module and a bottom layer supporting module, wherein the system function module comprises a data file management module, a preprocessing module, a forward module, an inversion module and an image-forming module; the bottom layer supporting module comprises a data file IO module, an embedded type database module, a universal math library module, a universal signal processing library module and an 2D/3D graphics library module; and the bottom layer supporting module is used for providing a universal performance function for the system function module.

2. The semi-airborne time domain electromagnetic exploration system for the unmanned aerial vehicle according to claim 1, wherein the receiving coil is a hollow core induction coil wound by a copper wire, comprises a coil and a differential preamplifier connected to both ends of the coil, and is used to detect electromagnetic response signals of geological bodies in the exploration areas

3. The semi-airborne time domain electromagnetic exploration system for the unmanned aerial vehicle according to claim 1, wherein the receiving coil is hung below the unmanned aerial vehicle by a nylon belt, and the nylon belt and the receiving coil are connected by a spring shock absorber.

4. The semi-airborne time domain electromagnetic exploration system for the unmanned aerial vehicle according to claim 1, wherein the receiver is encapsulated in an aluminum metal shell, and is mounted under the unmanned aerial vehicle through a bracket and an airbag shock absorber.

5. The semi-airborne time domain electromagnetic exploration system for the unmanned aerial vehicle according to claim 1, wherein the receiver comprises an analog signal conditioning module, a signal acquisition module based on ADC and FPGA, an ARM embedded system control module, a GPS transceiver synchronization module, a CF card storage module, a WIFI module, an attitude sensor and a laser altimeter; and the signal detected by the receiving coil is amplified, filtered and stored by the receiver in real time.

6. The semi-airborne time domain electromagnetic exploration system for the unmanned aerial vehicle according to claim 5, wherein the analog signal conditioning module is connected to the differential preamplifier of the receiving coil through a shielded wire to amplify and filter the received weak detection signal and convert it into a level matching with the ADC input end; the signal acquisition module based on ADC and FPGA starts ADC sampling every second under control of the second synchronization pulse of the ARM embedded system control module, converts the analog signal into a digital signal, and encapsulates it into a frame for being stored into the CF card storage module; the GPS transceiver synchronization module is connected to an external GPS antenna for providing real-time coordinates and time information as well as the second synchronization pulse to the receiver; the WIFI module is connected to a handheld terminal for setting parameters of the receiver; the attitude sensor is attached to a receiving coil housing; the attitude sensor is kept consistent with the receiving coil in motion attitude, and is connected to the receiver through a RS-485 bus; the laser altimeter is mounted under the unmanned aerial vehicle and is perpendicular to the horizontal plane of the machine body of the unmanned aerial vehicle; a laser emitting and receiving hole faces towards the ground; and the laser altimeter is used for measuring relative height of the unmanned aerial vehicle and the ground.

7. The semi-airborne time domain electromagnetic exploration system for the unmanned aerial vehicle according to claim 1, wherein output current of the ground high-power electromagnetic field source emission subsystem is 50-100 A, the emission fundamental frequency is 1.25-200 Hz, the maximum rated power is 30 KW, the output current stability is less than ±1%, and the turn-off time is less than 20 μs.
